(19) United States
(12) Patent Application Publication
(10) Pub. No.: US 2015/0294031 A1
(43) Pub. Date: Oct. 15, 2015

(54) Predicting the Carbon Footprint of Urban Stormwater Infrastructure

(71) Applicant: Carbon Storm, Inc., Durham, NC (US)

(72) Inventors: Yuehua Liu, Chapel Hill, NC (US); Trisha Lynn Moore, Manhattan, KS (US); Julia C. Hunt, Cary, NC (US); Leshan M. Fernando, Durham, NC (US)

(21) Appl. No.: 14/252,238

(22) Filed: Apr. 14, 2014

(51) Int. Cl. G06F 17/50

(52) U.S. Cl. CPC G06F 17/50

(57) ABSTRACT

A planning system for planning the landscaping of a particular piece of land in terms of carbon footprint models predefined types of stormwater management infrastructure and assists a user in constructing a plan for managing the land's stormwater according to carbon footprint. The net carbon footprint of the plan is calculated according to type-specific equations that formulate carbon embodied in the materials, emitted during the construction, emitted during the maintenance, and sequestered by the materials of the one or more types of stormwater management infrastructure employed by the plan. The user is then presented with information useful for determining the net carbon footprint or determining a plan that most closely achieves a target net carbon footprint.

### BACKGROUND

There is an emerging need for land developers to be able to estimate, a priori, the carbon emissions and sequestration potential of residential, commercial, or other developments. Web-based carbon footprint calculators and narrow academic studies of specific landscape types have attempted to meet this need. The planning of a landscape is in practice, however, a much more complex design problem than merely calculating how much carbon a patch of grass emits or sequesters. In particular, stormwater management infrastructure involves a broad diversity of materials, construction, maintenance and sequestration concerns that are not addressed by existing solutions.

### SUMMARY

In exemplary embodiments of the present disclosure, a planning system for planning the landscaping of a particular piece of land in terms of carbon footprint can model predefined types of stormwater management infrastructure and assist the user in constructing a plan for managing the land's stormwater. The net carbon footprint of the plan is calculated according to type-specific equations that formulate carbon embodied in the materials, emitted during the construction, emitted during the maintenance, and sequestered by the materials of the one or more types of stormwater management infrastructure employed by the plan. The user is then presented with information useful for determining the net carbon footprint or determining a plan that most closely achieves a target net carbon footprint.

Exemplary embodiments of the disclosure comprise methods, implemented by one or more processing circuits of a planning system, for planning the landscaping of a particular piece of land in terms of carbon footprint. In one exemplary embodiment, the method comprises modeling predefined types of stormwater management infrastructure as predefined sets of parameters characterizing the dimensions, materials, construction, and maintenance specific to each predefined type, including restricting possible values of at least one parameter characterizing materials, construction, and maintenance to one or more predefined values. The method further comprises assisting a user to construct alternative plans for managing the land's stormwater that differ in the one or more predefined types of stormwater management infrastructure that the plans employ and/or in the dimensions, materials, construction, or maintenance of a predefined type of infrastructure common to the plans. This assisting comprises presenting the user with decisions about how to manage the land's stormwater and forming the alternative plans based on how the user makes those decisions. These decisions include a decision about which one or more of the predefined types of stormwater management infrastructure to employ and decisions about the values to assign to parameters characterizing the dimensions, materials, construction, and maintenance specific to each predefined type employed. The method further comprises calculating a net carbon footprint of each alternative plan by calculating the individual carbon footprint of each predefined type of stormwater management infrastructure included in that plan according to type-specific equations and aggregating the individual carbon footprints if the user includes multiple types in the plan. The type-specific equations formulate any carbon embodied in the materials, emitted during the construction, emitted during the maintenance, and sequestered by the materials of a type of stormwater management infrastructure as a function of the values assigned by the user to parameters characterizing the dimensions and/or materials specific to that type. Finally, the method further comprises presenting, to the user, information identifying one or more of the alternative plans and/or one or more of the net carbon footprints for determining which of the alternative plans most closely achieves a target net carbon footprint.

In some embodiments, forming the alternative plans comprises forming the alternative plans exclusively from the decisions made by the user such that the alternative plans are explicitly specified by the user.

In some embodiments, forming the alternative plans comprises identifying an unmade decision as a decision that was presented to the user but that was not made by the user and autonomously forming different alternative plans from different possible ways that the user could have made that decision. In one embodiment, the unmade decision is a decision between which of multiple predefined values to assign to a parameter characterizing the dimensions, materials, construction, or maintenance specific to a type of stormwater management infrastructure to be employed. In one embodiment, the further comprises evaluating the net carbon footprints to identify which of the alternative plans most closely achieves the target net carbon footprint, and said presenting comprises presenting information identifying the alternative plan that most closely achieves the target net carbon footprint so as to inform the user of how to make the unmade decision.

In some embodiments, the method further comprises evaluating the net carbon footprints to identify which of the alternative plans most closely achieves the target net carbon footprint, and wherein said presenting comprises presenting information identifying that alternative plan.

In some embodiments, calculating the net carbon footprint of an alternative plan that employs multiple types of stormwater management infrastructure comprises calculating that footprint to exclude carbon emissions eliminated by simultaneously constructing and/or maintaining those types with the same equipment.

In some embodiments, the predefined types of stormwater management infrastructure include two or more of a bioretention cell, a bioinfiltration cell, permeable pavement, a stormwater detention basin, a rainwater cistern, a sand filter, a wetland, a green roof, a level spreader, a vegetated filter strip, a reinforced concrete pipe, a concrete channel, a rock-lined channel, and a swale.

In some embodiments, one of said parameters characterizing the materials specific to a predefined type characterizes a kind or mix of vegetation employed by that predefined type, the possible values of that parameter being restricted to multiple predefined kinds or mixes of vegetation.

In some embodiments, one of said parameters characterizing the construction or maintenance specific to a predefined type characterizes a class or payload size of equipment employed for that construction or maintenance, the possible values of that parameter being restricted to multiple predefined classes or payload sizes.

In some embodiments, the type-specific equations formulate carbon emitted during the maintenance of a type of infrastructure that has a mulched area to account for the replacement and/or decomposition of the mulch in that area over time, as a function of the dimensions of the mulched area.

In some embodiments, the type-specific equations formulate carbon emitted during the maintenance of a type of infrastructure that has pavement to account for the sweeping of that pavement, as a function of the dimensions of that pavement.

In some embodiments, the type-specific equations formulate carbon emitted during the maintenance of a type of infrastructure that has a forebay to account for the cleanout of that forebay, as a function of the dimensions of that forebay.

In some embodiments, the type-specific equations formulate carbon sequestered by the trees or turf of a type of infrastructure that has such trees or turf, as a function of the values respectively assigned by the user to parameters characterizing the kind of such trees or turf.

In some embodiments, the type-specific equations formulate carbon sequestered by a rainwater cistern to account for the amount of potable water conserved over a defined time by re-using stormwater rather than that potable water.

In some embodiments, said alternative plans are also for landscaping the land with hardscapes and/or greenscapes. Further, said modeling further comprises modeling predefined types of hardscapes and/or greenscapes as predefined sets of hardscape and/or greenscape parameters characterizing the dimensions, materials, construction, and maintenance specific to each of those predefined types, including restricting possible values of at least one hardscape and/or greenscape parameter characterizing materials, construction, and maintenance to one or more predefined values. In addition, said assisting further comprises presenting the user with decisions about which one or more of the predefined types of hardscapes and/or greenscapes to employ and decisions about the values to assign to hardscape and/or greenscape parameters characterizing the dimensions, materials, construction, and maintenance specific to each of those predefined types employed. Finally, calculating the net carbon footprint of each alternative plan comprises calculating the individual carbon footprint of each predefined type of hardscape and/or greenscape included in that plan according to type-specific hardscape and/or greenscape equations and aggregating those individual carbon footprints if the user includes multiple types of hardscapes and/or greenscapes in the plan, wherein the type-specific hardscape and/or greenscape equations formulate any carbon embodied in the materials, emitted during the construction, emitted during the maintenance, and sequestered by the materials of a type of hardscape and/or greenscape as a function of the values assigned by the user to parameters characterizing the dimensions and/or materials specific to that type.

Other embodiments comprise methods, implemented by one or more processing circuits of a planning system, for planning the landscaping of a particular piece of land in terms of carbon footprint. In one exemplary embodiment, the method comprises modeling predefined types of stormwater management infrastructure as predefined sets of parameters characterizing the dimensions, materials, construction, and maintenance specific to each predefined type, including restricting possible values of at least one parameter characterizing materials, construction, and maintenance to one or more predefined values. The method further comprises constructing a plan for managing the land's stormwater by presenting the user with decisions about the plan and forming the plan based on how the user makes those decisions, said decisions including a decision about which one or more of the predefined types of stormwater management infrastructure to include in the plan and decisions about the values to assign to parameters characterizing the dimensions, materials, construction, and maintenance specific to each predefined type included in the plan. The method further comprises calculating a net carbon footprint of the plan by calculating the individual carbon footprint of each predefined type of stormwater management infrastructure included in the plan according to type-specific equations and aggregating the individual carbon footprints if the user includes multiple types in the plan, wherein the type-specific equations formulate any carbon embodied in the materials, emitted during the construction, emitted during the maintenance, and sequestered by the materials of a type of stormwater management infrastructure as a function of the values assigned by the user to parameters characterizing the dimensions and/or materials specific to that type. Finally, the method further comprises presenting the net carbon footprint of the plan to the user.

In some embodiments, the predefined types of stormwater management infrastructure include two or more of a bioretention cell, a bioinfiltration cell, permeable pavement, a stormwater detention basin, a rainwater cistern, a sand filter, a wetland, a green roof, a level spreader, a vegetated filter strip, a reinforced concrete pipe, a concrete channel, a rock-lined channel, and a swale.

In some embodiments, one of said parameters characterizing the materials specific to a predefined type characterizes a kind or mix of vegetation employed by that predefined type, the possible values of that parameter being restricted to multiple predefined kinds or mixes of vegetation.

In some embodiments, one of said parameters characterizing the construction or maintenance specific to a predefined type characterizes a class or payload size of equipment employed for that construction or maintenance, the possible values of that parameter being restricted to multiple predefined classes or payload sizes.

In some embodiments, the type-specific equations formulate carbon emitted during the maintenance of a type of infrastructure that has a mulched area to account for the replacement and/or decomposition of the mulch in that area over time, as a function of the dimensions of the mulched area.

In some embodiments, the type-specific equations formulate carbon emitted during the maintenance of a type of infrastructure that has pavement to account for the sweeping of that pavement, as a function of the dimensions of that pavement.

In some embodiments, the type-specific equations formulate carbon emitted during the maintenance of a type of infrastructure that has a forebay to account for the cleanout of that forebay, as a function of the dimensions of that forebay.

In some embodiments, the type-specific equations formulate carbon sequestered by the trees or turf of a type of infrastructure that has such trees or turf, as a function of the values respectively assigned by the user to parameters characterizing the kind of such trees or turf.

In some embodiments, the type-specific equations formulate carbon sequestered by a rainwater cistern to account for the amount of potable water conserved over a defined time by re-using stormwater rather than that potable water.

In some embodiments, said plan is also for landscaping the land with hardscapes and/or greenscapes. Further, said modeling further comprises modeling predefined types of hardscapes and/or greenscapes as predefined sets of hardscape and/or greenscape parameters characterizing the dimensions, materials, construction, and maintenance specific to each of those predefined types, including restricting possible values of at least one hardscape and/or greenscape parameter characterizing materials, construction, and maintenance to one or more predefined values. In addition, said constructing further comprises presenting the user with decisions about which one or more of the predefined types of hardscapes and/or greenscapes to include in the plan and decisions about the values to assign to hardscape and/or greenscape parameters characterizing the dimensions, materials, construction, and maintenance specific to each of those predefined types included in the plan. Finally, calculating the net carbon footprint of the plan comprises calculating the individual carbon footprint of each predefined type of hardscape and/or greenscape included in the plan according to type-specific hardscape and/or greenscape equations and aggregating those individual carbon footprints if the user includes multiple types of hardscapes and/or greenscapes in the plan, wherein the type-specific hardscape and/or greenscape equations formulate any carbon embodied in the materials, emitted during the construction, emitted during the maintenance, and sequestered by the materials of a type of hardscape and/or greenscape as a function of the values assigned by the user to parameters characterizing the dimensions and/or materials specific to that type.

Embodiments herein further include hardware configured to perform the above-described methods.

Embodiments herein further include a computer program product stored in a non-transitory computer readable medium for controlling a programmable hardware planning system, the computer program product comprising software instructions which, when run on the programmable hardware planning system, causes the programmable network entity to perform the above-described methods.

### BRIEF DESCRIPTION OF THE DRAWINGS

FIG. 1 is a block diagram of an operating environment for a landscape planning system according to one or more embodiments.

FIG. 2 is a logic flow diagram of a method implemented by a planning system for planning the landscape of a particular piece of land according to one or more embodiments.

FIG. 3 is a logic flow diagram of a more detailed method implemented by a planning system for planning the landscape of a particular piece of land according to one or more embodiments.

FIG. 4 illustrates an example model of predefined types of stormwater management infrastructure, according to one or more embodiments.

FIG. 5 illustrates an example of a user constructing alternative plans for managing the land's stormwater, according to one or more embodiments.

FIG. 6 illustrates an example of autonomously forming alternative plans from different possible ways that a user could have made a decision, according to one or more embodiments.

FIG. 7 is a block diagram that illustrates the calculation of a net carbon footprint of a plan.

FIG. 8 illustrates an example of presenting information identifying the alternative plan that most closely achieves a target net carbon footprint, according to one or more embodiments.

FIG. 9 is a logic flow diagram of a further method implemented by a planning system for planning the landscape of a particular piece of land according to one or more embodiments.

FIG. 10 illustrates a user interface for assisting a user to construct a plan by presenting the user with decisions about construction, according to one or more embodiments.

FIG. 11 illustrates a user interface for assisting a user to construct a plan by presenting the user with decisions about maintenance and carbon sequestering materials, according to one or more embodiments.

FIG. 12 is a block diagram of exemplary hardware useful for implementing the planning system, according to one or more embodiments.

### DETAILED DESCRIPTION

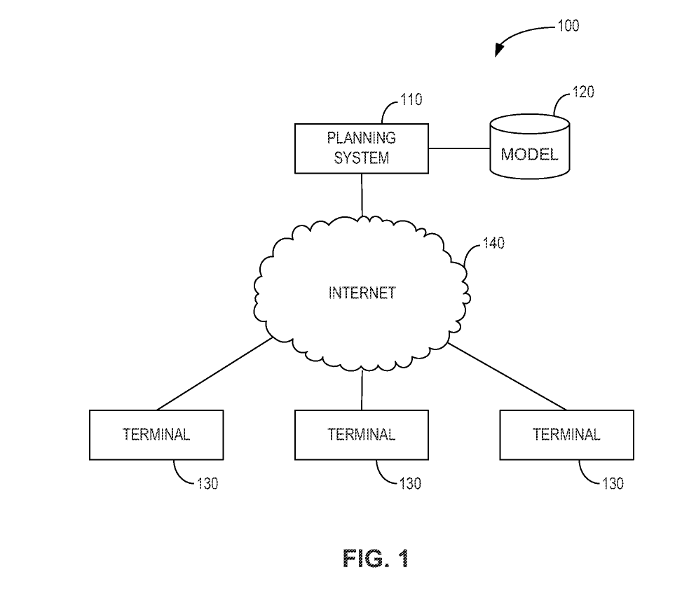

FIG. 1 illustrates an example operating environment 100 for a landscape planning system 110. The operating environment 100 comprises a communications network, such as an IP-based packet-switched communications network. The operating environment 100 comprises a planning system 110 that uses a model 120 to model predefined types of stormwater management infrastructure. The planning system 110 is connected to one or more terminals 130 via the Internet 140 or other wide area network. In this operating environment 100, users are able to use the planning system 110 locally by being physically present at the planning system 110, or they are able to use the planning system 110 remotely via one of the terminals 130.

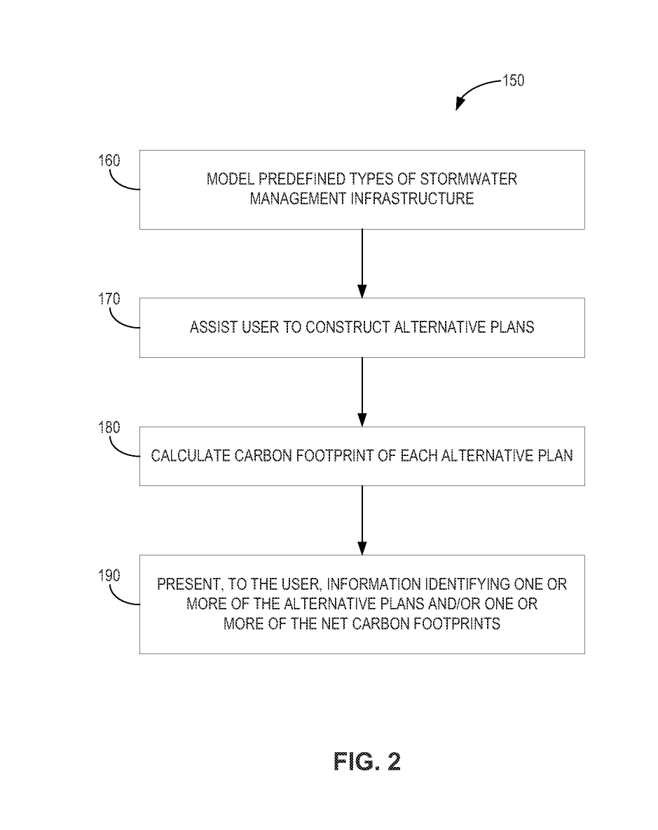

FIG. 2 illustrates an exemplary method 150 for planning the landscaping of a particular piece of land in terms of a carbon footprint. The particular piece of land may be of any scale, from an individual lot, to a subdivision, to a municipality, to a metro-region, etc. The method is implemented by one or more processing circuits of the planning system 110. The method includes modeling predefined types of stormwater management infrastructure (block 160). These types of stormwater management infrastructure include, for example, two or more of a bioretention cell, a bioinfiltration cell, permeable pavement, a stormwater detention basin, a rainwater cistern, a sand filter, a wetland, a green roof, a level spreader, a vegetated filter strip, a reinforced concrete pipe, a concrete channel, a rock-lined channel, and a swale.

Regardless, the different predefined types of infrastructure are modeled respectively as different predefined sets of parameters. The parameters in any given predefined set characterize the dimensions, materials, construction, and maintenance that are specific to the predefined type of infrastructure modeled by those parameters. In at least some embodiments, more than one parameter characterizes any of such dimensions, materials, construction, and maintenance. For example, height, width, and depth parameters characterize the dimensions specific to a particular type of infrastructure.

Although some of the parameters may take on any value, the model herein advantageously restricts the possible values of at least one parameter characterizing materials, construction, and/or maintenance. That is, the possible values of such a parameter are restricted to one or more predefined values. For example, the value of a parameter characterizing the materials of a bioretention cell may be restricted to different predefined kinds or mixes of vegetation, including hardwood trees only, softwood trees only, or a mix thereof according to ratios specified by the user. Additionally or alternatively, the value of a parameter characterizing the type of equipment used for transporting the materials that will be needed to construct a bioretention cell may be restricted to different predefined types of equipment, including for instance dump trucks that have different predefined payload sizes and/or power classes.

In any event, the method 150 in FIG. 2 further includes assisting a user to construct alternative plans for managing the land's stormwater (block 170). The alternative plans constructed differ in the one or more predefined types of stormwater management infrastructure that the plans employ, and/or in the dimensions, materials, construction, or maintenance of a predefined type of infrastructure common to the plans. In order to assist the user to construct these alternative plans, the planning system 110 presents the user with decisions about how to manage the land's stormwater, and then forms the alternative plans based on how the user makes those decisions. These decisions include a decision about which one or more of the predefined types of stormwater management infrastructure to employ. The decisions also include decisions about the values to assign to parameters characterizing the dimensions, materials, construction, and maintenance specific to each predefined type of infrastructure employed. For parameters whose possible values are restricted to one or more predefined values, this means presenting only those predefined values to the user to select from (e.g., by presenting the predefined values in a drop down menu).

Having formed the alternative plans, the planning system 110 calculates a net carbon footprint of each alternative plan (block 180). The planning system 110 calculates the net carbon footprint for a particular plan by calculating the individual carbon footprint of each predefined type of stormwater management infrastructure included in that plan. The planning system 110 aggregates those individual carbon footprints if the user includes multiple types of infrastructure in the plan.

The planning system 110 calculates the individual carbon footprint for a given predefined type of stormwater management infrastructure according to equations that are specific to that type of infrastructure. These equations formulate any carbon embodied in the materials, emitted during the construction, emitted during the maintenance, and sequestered by the materials of the given type of stormwater management infrastructure, as a function of the values assigned by the user to parameters characterizing the dimensions and/or materials specific to that given type.

For example, an equation formulating the carbon emitted during the construction of a particular type of infrastructure formulates the carbon emissions as a function of the values assigned by the user to parameters characterizing the dimensions specific to that type. Consider for instance an embodiment where the construction-induced carbon emissions account for the carbon emitted during the transport of a particular material to the construction site. In this case, the planning system 110 advantageously calculates the volume of material needed for the planned infrastructure based on the user-specified dimensions for the infrastructure, computes the number of trips and/or number of transportation vehicles (e.g., dump trucks) needed to transport that volume of material, and then calculates the carbon emissions attributable to such transport.

Finally, the planning system 110 presents, to the user, information identifying one or more of the alternative plans and/or one or more of the net carbon footprints for determining which of the alternative plans most closely achieves a target net carbon footprint (block 190). The target footprint in some embodiments is simply the minimum possible footprint among the alternative plans, while in other embodiments the target footprint is a particular footprint value. In either case, the planning system 110 in one or more embodiments just presents information identifying the alternative plans and the net footprints for those plans so that the user can determine which plan most closely achieves the target footprint. In one or more other embodiments, the planning system 110 actually compares the calculated net footprints to each other and/or to the target footprint to itself determine the plan which most closely achieves the target. In this case, the planning system 110 may then present information identifying that plan. Accordingly, the particular information presented to the user depends in some embodiments on how the planning system 110 is configured to be used.

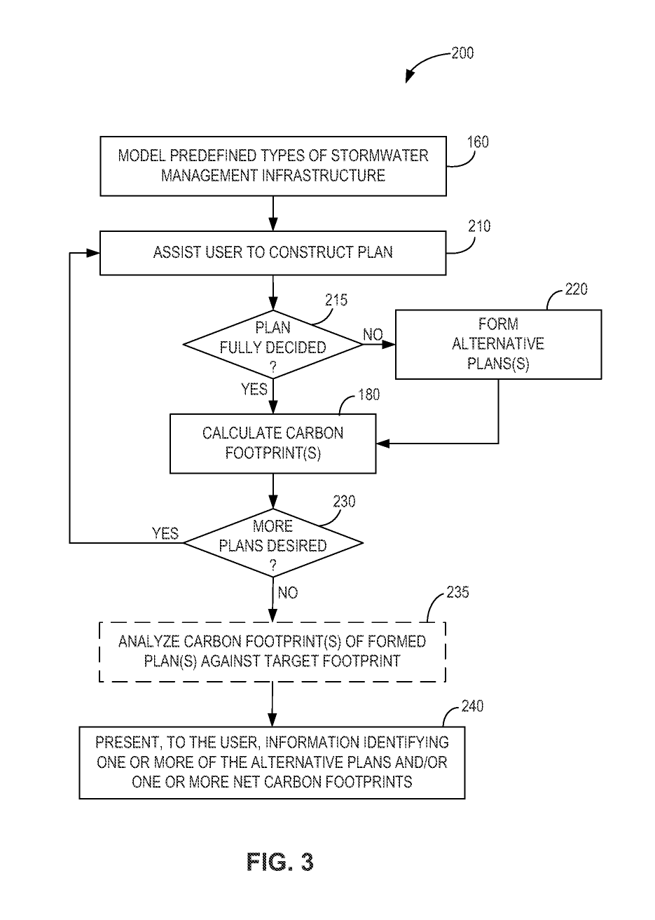

Additionally or alternatively, if the planning system 110 has been configured to be used in different ways, the information presented may depend on how the user decides to use the planning system 110. FIG. 3 illustrates processing 200 performed by the planning system 110 when the planning system 110 has been configured to be used in different ways, depending on how the user chooses.

Specifically, the planning system 110 in FIG. 3 is configured to be used to either (1) simply calculate the net footprint of alternative plans explicitly and fully specified by the user; or (2) autonomously identify alternative plans available to a user who does not know how to make a particular decision presented to him or her and then calculate the net footprint of those autonomously identified plans. When the user chooses to use the planning system 110 according to option (2), the information presented to the user may simply inform the user of the best way to make the decision that he or she did not know how to make; that is, the way to make the decision that achieves the target footprint.

More particularly, the processing 200 shown in FIG. 3 includes modeling predefined types of stormwater management infrastructure (block 160), as previously described. The method 200 also includes assisting a user to construct a plan by presenting the user with decisions about which one or more of the predefined types of stormwater management infrastructure to employ, and what values to assign to parameters characterizing the dimensions, materials, construction, and maintenance specific to each predefined type employed (block 210). The method 200 then evaluates whether the plan has been fully decided (block 215). If one or more of the presented decisions were left undecided by the user, the planning system 110 will autonomously form different alternative plans from the different possible ways that the user could have made that decision (block 220). If, however, the plan was fully decided by the user, then the plan will be formed exclusively from the decisions made by the user.

Whether the planning system 110 has autonomously formed different alternative plans, or a plan is formed exclusively from decisions made by the user, the processing 200 includes calculating a net carbon footprint for each of the plans, as previously described (block 180). The processing 200 then checks whether the user wishes to construct more plans (block 230). If so, the user is assisted in the construction of more plans (block 210).

Once all of the plans that the user desires have been formed, the processing 200 in some embodiments analyzes the carbon footprints that were calculated for the plans against a target footprint (block 235). Finally, the processing 200 presents, to the user, information identifying one or more plans and/or one or more net carbon footprints, as described above (block 240).

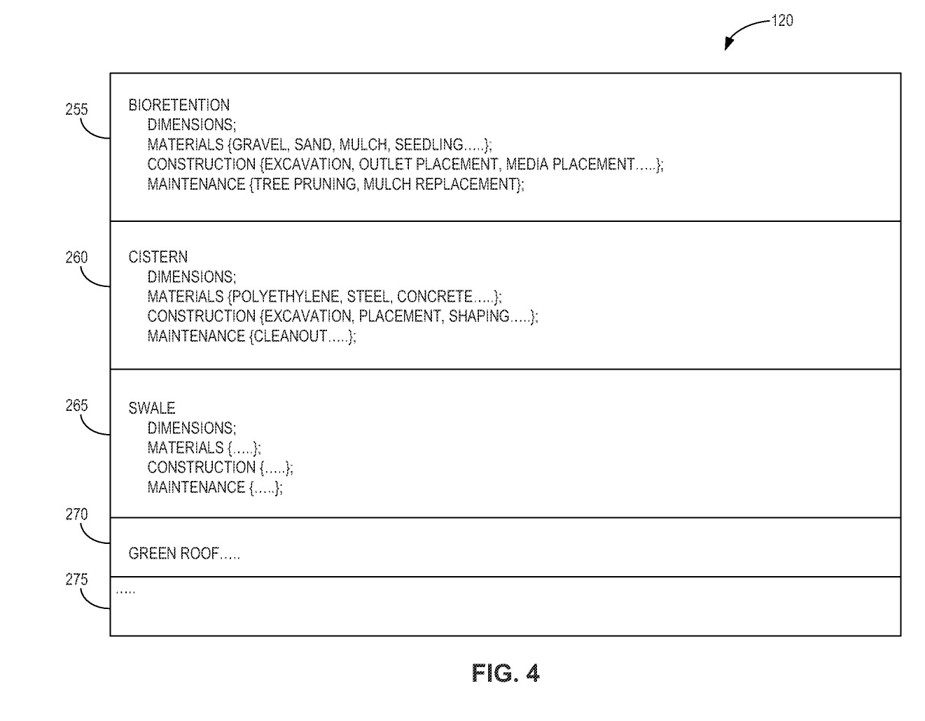

FIG. 4 illustrates an example model 120 of predefined types of stormwater management infrastructure. The predefined types of stormwater management infrastructure represented in the model 120 includes a bioretention cell 255, a rainwater cistern 260, a swale 165, and a green roof 270. Additional types 275 of stormwater management infrastructure include permeable pavement, a bioinfiltration cell, a stormwater detention basin, a sand filter, a wetland, a level spreader, a vegetated filter strip, a reinforced concrete pipe, a concrete channel, and a rock-lined channel. Model 120 is not limited, however, to only modeling stormwater management infrastructure. Predefined types of non-stormwater management infrastructure hardscapes and/or greenscapes are included in the additional types 275 in some embodiments. Although the modeling of stormwater management infrastructure will be discussed with particularity, the skilled practitioner will recognize how to extrapolate these principles to include non-stormwater management infrastructure hardscapes and/or greenscapes.

Each predefined type of stormwater management infrastructure is modeled as predefined sets of parameters characterizing the dimensions, materials, construction, and maintenance specific to each predefined type. This modeling includes restricting the possible values of at least one of these parameters. For example, a bioretention cell 255 is modeled in model 120 as having unrestricted dimensions. However, the materials that characterize that bioretention cell 255 are modeled to include gravel, sand, mulch, and seedling. Similarly, construction of a bioretention cell 255 is modeled to include excavation, outlet placement, and media placement. Similarly, maintenance of a bioretention cell 255 is modeled to include tree pruning and mulch replacement.

Although the parameters characterizing the dimensions, materials, construction, and maintenance are quite general as just described, the dimensions, materials, construction and/or maintenance in some embodiments are characterized with finer granularity (e.g., with more specific parameters). For example, construction of a bioretention cell 255 in some embodiments is modeled with additional parameters that more specifically describe how excavation is accomplished. One additional parameter for instance may describe the particular equipment used to perform excavation in terms of the particular type, engine, and/or horsepower of that equipment. In this case, the model may restrict the possible values of that parameter so as to model excavation using a 200 horsepower diesel excavator, excavation using a 150 horsepower gasoline backhoe, and so on. Other parameters characterizing dimensions, materials, construction, and/or maintenance are similarly restricted in other embodiments.

The modeling of each predefined type of stormwater management infrastructure includes restrictions regarding the possible values of parameters characterizing materials, construction, and maintenance for that type. For example, the materials of a bioretention cell 255, according to the model 120, is restricted by the model to gravel, sand, mulch, and seeding, whereas the materials of a rainwater cistern 260 are restricted by the model 120 to an entirely different set of materials, i.e., polyethylene, steel, and concrete. It is not required, however, that the values between types of stormwater management infrastructure be entirely disjoint. The possible values of a parameter can be common across stormwater infrastructure types. For example, a construction parameter of bioretention cell 255 and the construction parameter of rainwater cistern 260 both have excavation as a possible value, under the model 120.

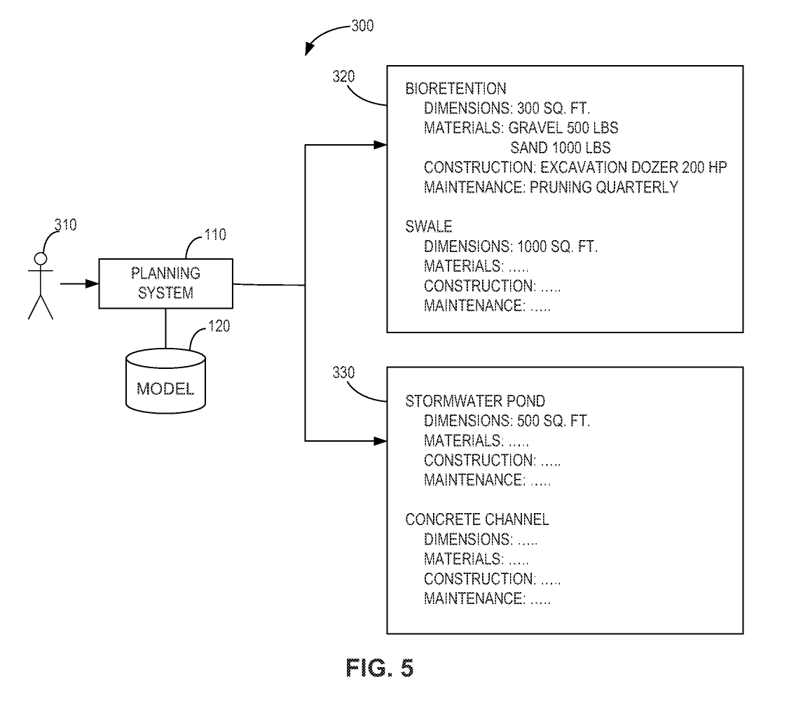

Having modeled the predefined types of stormwater management infrastructure, a user is assisted in the construction of alternative plans for managing the land's stormwater. FIG. 5 illustrates an example of a user 310 constructing 300 these alternative plans 320, 330. For example, planning system 110 makes use of model 120 to present the user 310 with decisions regarding which one or more of the predefined types of stormwater management infrastructure to employ. Accordingly, in a first plan 320, the user 310 decides to employ a bioretention cell and a swale, while in a second plan 330, the user 310 decides to employ a detention basin and a concrete channel. Other combinations, quantities and varieties of stormwater management infrastructure types are also possible, for a given plan.

The planning system 110 further makes use of model 120 to present the user 310 with decisions regarding values to assign to parameters characterizing the dimensions, materials, construction, and maintenance specific to each predefined type employed. Thus, the user 310 is presented with a decision regarding the dimensions of the bioretention cell, the materials to be used, the construction methods to be employed, and the maintenance plan to adopt. Because the model 120 restricts the possible values for these parameters, the decisions presented to the user 310 reflect these limitations. For example, if the user has selected a bioretention cell for plan 320, the user is presented with a decision to select one or more materials for the bioretention cell from a list of only those materials indicated in the model as possible for that type. For example, the user 310 is allowed to only select one or more of gravel, sand, mulch, and seeding as a material for the bioretention cell in plan 320. The user 310 therefore decides that the bioretention cell should use 500 pounds of gravel, and 1,000 pounds of sand. However, where a parameter is not restricted by the model 120, the user 310 is allowed to decide whatever value they like. For example, since the dimensions of a bioretention cell are not restricted by the model 120, user 310 is permitted to decide on a bioretention cell of any size.

When a parameter characterizing the materials specific to a predefined type characterizes a kind or mix of vegetation employed by that predefined type, the possible values of that parameter are restricted by model 120 to multiple predefined kinds or mixes of vegetation. If the user selects a different stormwater management infrastructure type, the user will be presented with different decisions. For example, the materials parameters for a bioretention cell can be restricted to hardwood trees, softwood trees, shrubs, and turf, or a mix thereof according to ratios specified by the user. The decisions presented to the user would be limited to these values.

When a parameter characterizing the construction or maintenance specific to a predefined type characterizes a class or payload size of equipment employed for that construction or maintenance, the possible values of that parameter are restricted to multiple predefined classes or payload sizes. For example, the maintenance parameters for a swale can be restricted to a 15 horsepower mower, a 50 horsepower mower, etc. Similarly, the construction parameters for a swale can be restricted to a 120 horsepower excavator and an 80 horsepower excavator, a class 8 dump truck, a class 7 box truck, and a class 1 pickup truck. The U.S. Department of Transportation defines vehicle weight rating classes that can be adopted as value restrictions for use in the model, and the decisions presented to the user with regard to construction and maintenance can be restricted to these values.

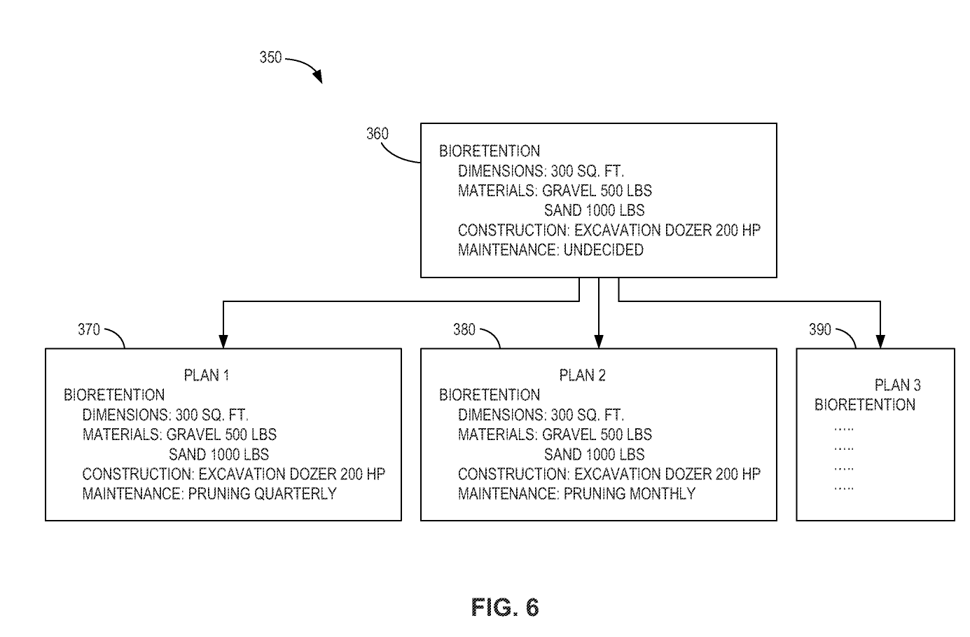

The user 310 is also permitted to leave a particular decision undecided. If the user 310 leaves a decision undecided, the planning system 110 will autonomously form different alternative plans 370, 380, 390 from different possible ways that the user could have made that decision. FIG. 6 illustrates an example of autonomously forming 350 these different alternative plans 370, 380, 390. For example, planning system 110 has assisted the user 310 in constructing a simple plan 360 that includes only a single bioretention cell. The user 310 has decided upon values for the dimensions, materials, and construction of the bioretention cell. The maintenance parameter of the simple plan 360, however, has been left undecided. Model 120 restricts the possible values for the maintenance parameter of a bioretention cell to tree pruning that occurs quarterly, monthly, and other predefined values. In such a case, the planning system 110 autonomously forms plan 370 that specifies pruning quarterly for the maintenance parameter, because the user 310 could have made such a decision according to the model 120. The planning system 110 also autonomously forms plan 380 that specifies pruning monthly, since pruning monthly was also a decision that the user 310 could have made with regard to the maintenance parameter, according to the model 120. Plan 380 can be autonomously formed in addition to, or instead of, plan 370, according to various embodiments. Similarly, the planning system 110 also autonomously forms plan 390, according to some other predefined value that the user 310 could have used to decide the maintenance parameter, according to model 120.

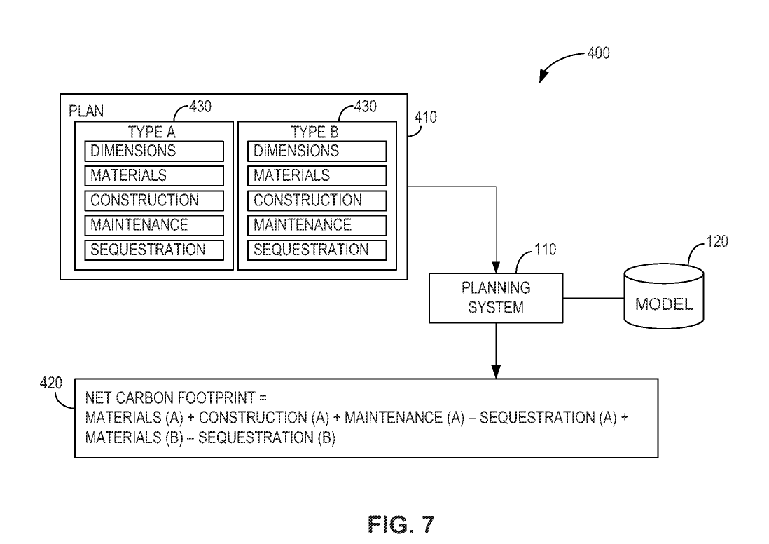

Whether formed exclusively from the decisions made by the user, or formed autonomously from different ways that the user could have made certain plan decisions, the planning system 110 calculates the net carbon footprint of the plan by making use of the model 120. FIG. 7 illustrates the calculation 400 of a net carbon footprint 420 of a plan 410, by the planning system 110, using the model 120. For example, plan 410 calls for two types 430 of stormwater management infrastructure. Thus, the calculation 400 would consider these two types 430. If type A of plan 410 calls for a 50 m³ polyethylene rainwater cistern, planning system 110 will refer to the model 120 to obtain an equation for calculating the kilograms of carbon embodied in the materials of polyethylene cisterns. For example, the equation x=(ab+c)d can be returned by the model, wherein a represents the mass, in kilograms, of polyethylene per cubic meter of cistern volume, b represents the volume of the cistern in cubic meters, c represents a constant that applies to all polyethylene cisterns, d represents the mass of carbon per unit mass of polyethylene, and x represents the kilograms of carbon embodied in the materials of a polyethylene cistern. Using this equation, if cistern has a volume of 50 m³, a unit of polyethylene weighs 29.57 kg per m³ cistern volume, a carbon density of 0.71 kg C per kg of polyethylene, and a constant of −101.8 is indicated for polyethylene cisterns by the model 120, calculating the carbon embodied in the materials of the planned cistern computes to 977.3 kilograms of carbon embodied in the cistern materials (i.e., (29.57×50−101.8)×0.71=997.3).

The type-specific equations provided by the model 120 will also formulate carbon sequestered by the rainwater cistern to account for the amount of potable water conserved over a defined time by re-using stormwater rather than potable water. An equation for carbon sequestered by a rainwater cistern can be expressed as x=0.6(V×Q×H/746)−(0.0967 C), wherein V represents the cubic meters of water use per year, Q represents the cubic meters of water pumped by the cistern pump per hour, H represents the horsepower of the cistern pump, and x represents the kilograms of carbon sequestered by the rainwater cistern called for by the plan. The constant 746 represents the number of watts a unit horsepower. The constant 0.0967 represents the energy embodied in a kilogram of potable water. The pump used for the cistern can be equipment that is characterized in the plan by a class or payload size in order to determine the horsepower H to use in such a cistern sequestration equation.

The type-specific equations provided by the model 120 will also formulate the carbon emitted during construction of the cistern, and the carbon emitted during maintenance of the cistern. Since materials, construction, and maintenance all increase the net carbon footprint, and sequestration reduces the net carbon footprint, an equation for net carbon footprint could be generically represented as Net Footprint=Materials+Construction+Maintenance−Sequestration. It is of note that some of these factors, such as materials and construction, have a one-time impact to the carbon footprint, whereas other factors, such as maintenance and sequestration, have a recurring impact to the carbon footprint. Thus, equations for computing the contribution of maintenance and sequestration may each be multiplied by the expected lifetime of the type 430 of stormwater management infrastructure. For example, if it is expected that a polyethylene rainwater cistern must be replaced every 20 years, then the model can provide maintenance and sequestration equations that compute maintenance costs over the course of a year, and multiplies each of those equations amount by 20 years. Alternatively, if the cistern is a temporary structure, the equations may instead be multiplied by the time the structured is planned to remain part of the landscape.

For plans that employ types of stormwater management infrastructure that include mulched areas (e.g., a bioretention cell), the type-specific equations provided by the model 120 will in some embodiments formulate carbon emitted during the maintenance of those mulched areas to account for the replacement and/or decomposition of mulch in that area over time, as a function of the dimensions of the mulch area. An equation for mulch decomposition can be expressed as x=m² (1.47t+1.091), wherein m² represents the square meters of mulched area, t represents time in years, and x represents the total kilograms of carbon emitted due to mulch decomposition. An equation for mulch replacement can be expressed as x=f[(V×C)+(d×g)], wherein V represents mulch volume, C represents the carbon embodied in a unit of mulch, d represents the distance in miles driven to transport mulch and crew, g represents the fuel efficiency of the vehicle used in the mulch replacement, f represents the frequency of mulch replacement, and x represents the kilograms of carbon emitted by the mulch replacement maintenance called for by the plan. The vehicle to be used for the mulch replacement can be equipment that is characterized in the plan by a class or payload size in order to determine the fuel efficiency g to use in such a mulch replacement equation.

For plans that employ types of stormwater management infrastructure that include an area of pavement (e.g., permeable pavement), the type-specific equations provided by the model 120 will in some embodiments formulate carbon emitted during the maintenance of that pavement to account for sweeping that pavement, as a function of the pavement's dimensions. An equation for pavement sweeping can be expressed as x=e(d+(A/3)), wherein A represents the pavement area, d represents the distance a street sweeper must drive to the site, e represents the carbon emissions per mile driven by the street sweeper, and x represents the kilograms of carbon emitted by street sweeping maintenance called for by the plan. The street sweeper used for street sweeping can be equipment that is characterized in the plan by a class or payload size in order to determine the emissions per mile e to use in such a street sweeping equation.

For plans that employ types of stormwater management infrastructure that include a forebay (e.g., a stormwater detention basin), the type-specific equations provided by the model 120 will in some embodiments formulate carbon emitted during the maintenance of the forebay to account for the cleanout of that forebay, as a function of the dimensions of that forebay. An equation for forebay cleanout can be expressed as x=f[(d×g)+e (V/m)], wherein d represents the distance driven to the site by tractor trailer hauling equipment, g represents the carbon emitted by driving the tractor trailer hauling equipment per mile, V represents the volume of material in the forebay to be removed, m represents the volume of material an excavator can remove from the forebay per hour, e represents the carbon emitted by the excavator per hour of excavation, f represents the number of times per year that cleanout is performed, and x represents the kilograms of carbon emitted by perfoming forebay cleanout per year. The tractor trailer and excavator can be equipment that are characterized in the plan by a class or payload size in order to determine the carbon emitted e by the excavator per hour and the carbon emitted g by the tractor trailer per mile in such a forebay cleanout equation.

For plans that employ types of stormwater management infrastructures that include trees or turf (e.g., a green roof), the type-specific equations provided by the model 120 will in some embodiments formulate carbon sequestered by the trees or turf as a function of the values respectively assigned by the user to parameters characterizing the kind of such trees or turf. An equation for the carbon sequestered by a hardwood tree can be expressed as x=0.4143t^{1.8218} where t is the number of years the tree will operate to sequester carbon (e.g., the life-expectancy of the tree, the duration that the tree will be part of the plan), and x represents the total carbon sequestered by a hardwood tree. An equation for the carbon sequestered by a softwood tree can be expressed as x=0.159t²−0.4636t+2.2096, where t is the number of years the softwood tree will operate to sequester carbon, and x represents the total carbon sequestered by a softwood tree. An equation for the carbon sequestered by a shrub can be expressed as x=0.287t, where t is the number of years the shrub will operate to sequester carbon, and x represents the total carbon sequestered by a shrub. The equations can be respectively multiplied by the number of hardwood trees, softwood trees, and shrubs called for in the plan. Further, an equation for the carbon sequestered by irrigated turf can be expressed as x=(0.1t×A)−(V×C), where t is the number of years the irrigated turf will operate to sequester carbon, A represents the turf area, V represents the volume of irrigation water used, C is the carbon embodied in a volume of potable water, and x is the total carbon sequestered by irrigated turf. An equation for the carbon sequestered by non-irrigated turf can be expressed as x=(0.02t×A), where t is the number of years the non-irrigated turf will operate to sequester carbon, A represents the turf area, and x is the total carbon sequestered by non-irrigated turf.

Regardless of the particular type-specific equations, the planning system 110 in some embodiments will also identify that a plan 410 shares certain elements across types 430. For example, if type A is a rainwater cistern that requires excavation using a 50 horsepower backhoe for construction and type B is a concrete channel that also requires excavation using a 50 horsepower backhoe for construction, the planning system 110 will decide that this parameter should not contribute to the net carbon footprint 420 of the overall plan 410 twice. The planning system 110 will, therefore, decide that this parameter will contribute fully to the net carbon footprint 420 for one of the types, but will contribute at a reduced rate (or not at all) for the other, since the 50 horsepower backhoe will already be on-site, and there will only be an incremental carbon footprint impact by using it for additional construction duties. Similar measures will also be taken if a plan shares certain maintenance parameters. Thus, planning system 110 calculates 400 a net carbon footprint 420 by taking into consideration types 430 included in the plan 410, using the model 120 to obtain type-specific equations, and excluding emissions that would be eliminated by simultaneously constructing and/or maintaining those types 430, such as by using the same equipment across multiple types 430. Other embodiments will account for the carbon savings due to shared equipment through manual input. For example, the user could indicate that backhoe will travel 10 miles for construction of type A, but travel 0 miles for the construction of type B.

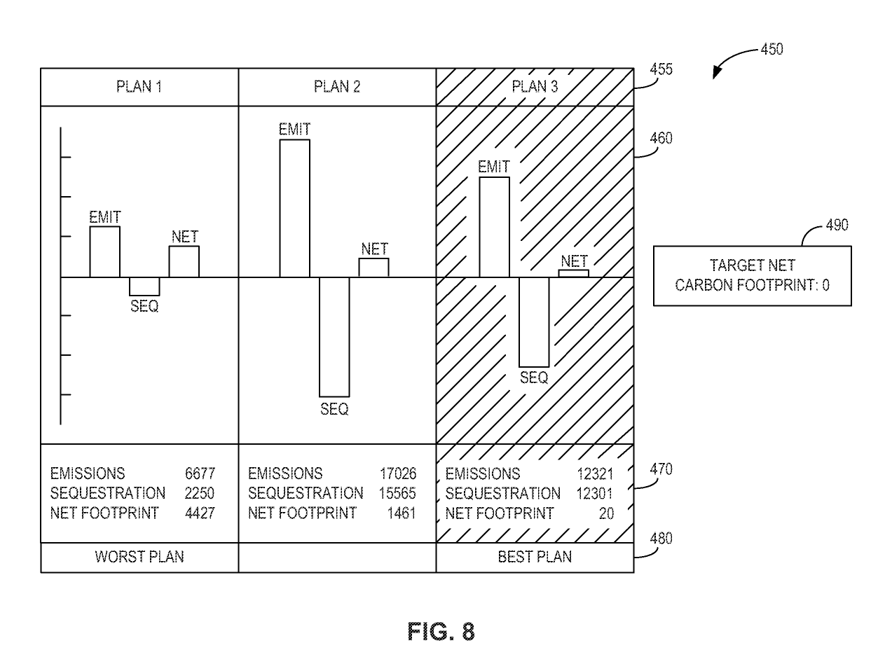

The net carbon footprint will be calculated for all plans that have been formed. FIG. 8 illustrates an example of presenting information 450 identifying the alternative plan that most closely achieves a target net carbon footprint 490. The information 450 includes a graphical representation 460 of the carbon emitted, carbon sequestered, and net carbon footprint, for one or more plans. In particular, graphical representation 460 comprises a bar graph for the plans. The information 450 also includes a numerical representation 470 of the carbon emitted, carbon sequestered, and net carbon footprint, for one or more plans. In particular, the numerical representation 470 is a table of values for the plans. The information 450 also includes information identifying the one or more plans 455. In particular, this information identifying the one or more plans 455 is a label describing the plan. In embodiments where the planning system 110 itself determines which plan most closely achieves the target net footprint, the system 110 also presents information 450 for determining which of the alternative plans most closely achieves a target net carbon footprint 490. As shown in the graphical representation 460, the plan that most closely achieves the target net carbon footprint is shaded, as is its numerical representation 470. The plan that most closely achieves a target net carbon footprint is also explicitly called out in a status area 480. Alternatively, the information 450 could have been presented for determining which of the alternative plans most closely achieves a target net carbon footprint 490 by presenting information about the best plan, and no others, for example.

The presented information 450 reflects how a plan with the most carbon emissions is not necessarily the worst plan. Plan 2 has the highest emissions of the three plans. However, even though Plan 1 emits less than 40% of the carbon emitted by Plan 2, Plan 2 outperforms Plan 1 due to the high amount of carbon Plan 2 sequesters. In fact, Plan 1 performs the worst of the three plans presented. The presented information 450 similarly reflects how a plan with the most sequestration is not necessarily the best plan. Plan 2 has the highest amount of sequestration of the three plans. However, even though Plan 3 sequesters less than 80% of the carbon sequestered by Plan 2, Plan 3 outperforms Plan 2 due to Plan 3's lower carbon emissions. By setting the target net carbon footprint 490 to zero, as shown in FIG. 8, the plan that is the most carbon-neutral will be identified, taking into consideration the emissions and sequestration of each respective plan.

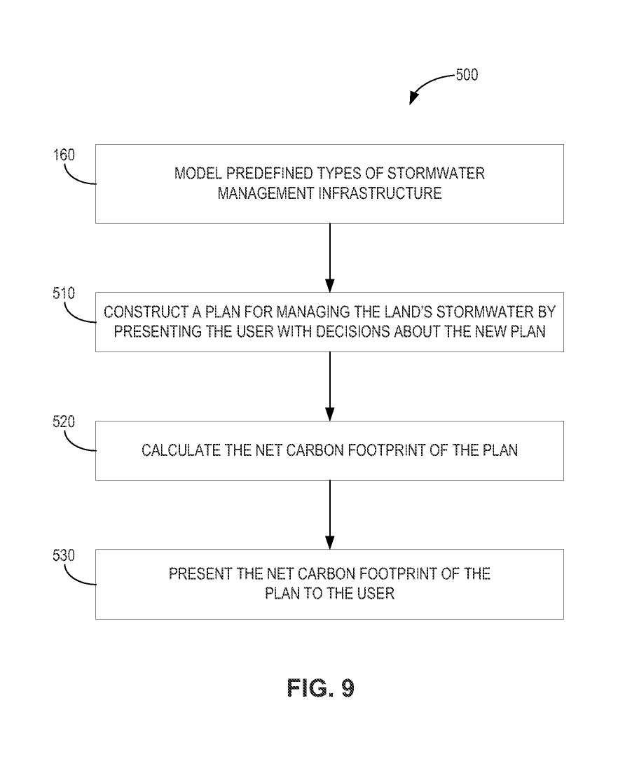

FIG. 9 illustrates a similar method 500, implemented by a planning system 110 for planning the landscape of a particular piece of land. The similar method 500 includes modeling predefined types of stormwater management infrastructure, as previously discussed (block 160). The similar method 500 also includes constructing a plan for managing the land's stormwater by presenting the user with decisions about the plan (block 510). Constructing the plan includes forming the plan based on how the user makes those decisions. The decisions include a decision about which one or more of the predefined types of stormwater management infrastructure to include in the plan. The decisions also include decisions about the values to assign to parameters characterizing the dimensions, materials, construction, and maintenance specific to each predefined type included in the plan.

The similar method 500 also includes calculating a net carbon footprint of the plan by calculating the individual carbon footprint of each predefined type of stormwater management infrastructure included in the plan according to type-specific equations (block 520). Calculating the net carbon footprint also includes aggregating the individual carbon footprints if the user includes multiple types in the plan. The type-specific equations formulate any carbon embodied in the materials, emitted during the construction, emitted during the maintenance, and sequestered by the materials of a type of stormwater management infrastructure as a function of the values assigned by the user to parameters characterizing the dimensions and/or materials specific to that type. Finally, the similar method 500 includes presenting the net carbon footprint of the plan to the user (block 530).

For a single landscape-type, the planning system 110 provides a user interface giving users the flexibility to enter and adjust different inputs and obtain corresponding footprint results. Users enter or adjust different inputs through a user interface and then view the corresponding footprint results for different inputs through the user interface. When this user interface is via a remote interface, such as a web interface, the computation of carbon footprint is not done on the user terminal, but on the planning system 110.

Typically, the model 120 will model several landscape types at the same time. The planning system 110 not only enables the computation of a plan that composites several landscape-types, but also allows the users the flexibility of selecting, adding or removing different landscape types to achieve a desired carbon footprint result through customization of a landscape design.

The planning system can thus be used to minimize carbon footprint by comparing the effects of different design parameters. In such case, the user selects a landscape type and specifies design, construction, and/or maintenance parameters through multiple scenarios. The resulting output is the effect of design, construction, and/or maintenance scenarios on the carbon footprint. For example, a user can specify the vegetation for a bioretention cell with the goal of minimizing the net carbon footprint of the system. The user uses the model 120 via the planning system 110 to test the effects of various vegetation specifications on the system carbon footprint, since the model 120 accounts for differences in rates of carbon sequestration by vegetation types and maintenance-associated emissions. This allows the user to contrast between a plan that adopts grass for all of its vegetation, against a plan that substitutes half that grass for 10 trees. The resulting differences in the carbon footprint will be presented in table form and/or graphically. Based on the greater quantity of carbon being sequestered by the plan that uses trees, the user will be able to decide on a mix of grass and trees to minimize the carbon footprint of the system.

The planning system 110 can also be used to optimize overall landscape design by carbon footprint. In such case, the user inputs a plan with multiple landscape types. The resulting output shows the effect of some landscapes or design parameters on the carbon footprint. For example, suppose a user needs a fixed area of pavement and would like to see if the inclusion of a bioretention cell will help to offset some of the carbon emissions. To do so, the user can create a first plan specifying three different landscape types: permeable pavement, standard pavement, and a bioretention cell. To see the effects without the bioretention cell, the user creates a second plan with only the standard and permeable pavements. All other selections between the first plan and the second plan would remain the same. The resulting carbon footprints are then displayed. Upon seeing the difference in carbon footprint between the two plans, and the particular benefits of a bioretention cell, the user will know how attractive building a bioretention cell will be.

The planning system 110 can also be used to determine the construction equipment, maintenance frequency, and/or mix of tree types that produce the minimal carbon footprint for a given stormwater management practice. In this case, the user may select one or more landscape types. By creating a series of model runs in which the type of construction equipment, maintenance routines, and/or vegetation specifications are changed, the user can determine the optimal design combinations that will achieve a minimal carbon footprint.

In some embodiments, therefore, the planning system 110 allows users to compare and optimize the carbon footprint of a landscape through adjustment of construction and environmental parameters. In at least one embodiment, the planning system 110 uses direct user inputs and drop down menus to allow the user to customize specific aspects of the design and construction of the landscape that affect the carbon footprint, thus allowing the user to compare the carbon footprint of multiple scenarios. Through selection of specific landscape types and associated design and construction parameters by users via direct user inputs and drop down menus, the planning system 110 provides users critical carbon footprint information to explicitly quantify when evaluating tradeoffs in parameters such as development cost or water quality.

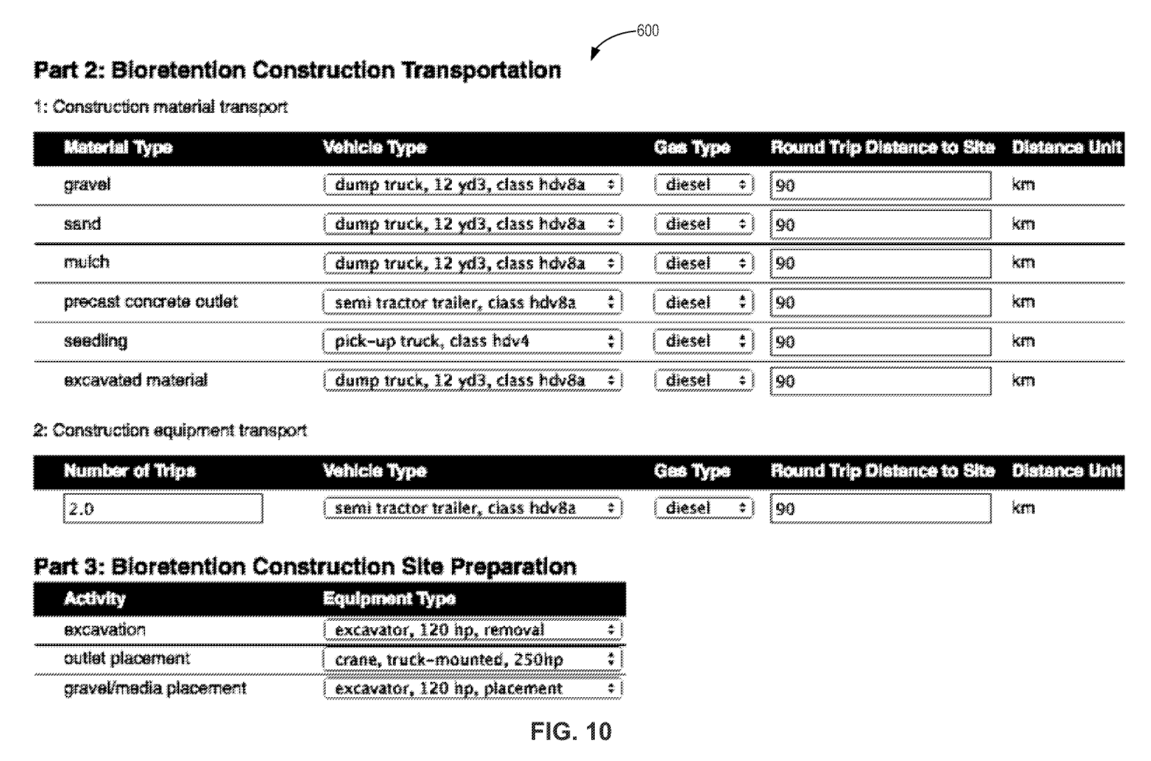

FIG. 10 illustrates a user interface 600 for assisting a user to construct a plan by presenting the user with decisions about construction. Part 2 of user interface 600 relates to the transportation of various materials involved in the plan. Because the user of user interface 600 has decided that gravel, sand, mulch, a precast concrete outlet, and seedling will be used as materials for a bioretention cell, the user is presented with decisions about transporting those materials to the site for construction of the bioretention cell. Further, because the user of user interface 600 has decided that excavation will be used for construction of the bioretention cell, the user is presented with decisions about transporting excavated material from the construction site. These decisions include the type of vehicle to be used, the gas type used by the vehicle, and the round trip distance to the site. The types of vehicles and gas type from which to choose from may be restricted, as indicated by the drop-down menus in FIG. 10 and as described above. In user interface 600, the user has decided that the gravel, sand, mulch, and excavated material will be hauled 90 kilometers by a 12 cubic yard, diesel-engine dump truck that is in heavy duty class 8a (as defined by the U.S. Department of Transportation). Seedling, however, will be hauled by a diesel-powered pick-up truck that is in truck classification 4, and the precast concrete outlet will be hauled by a diesel-powered semi-tractor trailer in truck classification 8a. The user is also presented with decisions for transporting construction equipment to the site, so that the user can plan for hauling equipment types that are not practical to drive themselves to the construction site (e.g., cranes, excavators). These decisions include the vehicle type, gas type, round trip distance, and number of trips to be made.

Part 3 of user interface 600 relates to the equipment to be used in preparing the construction site. Because the user has decided that construction will include excavation, outlet placement, and gravel/media placement, the user is presented with decisions regarding the equipment that will perform those construction activities. In user interface 600, the user has decided that 120-horsepower excavator will perform excavation and place gravel/media. For outlet placement, however, the user has decided that a 250-horsepower truck-mounted crane will be used.

By using drop-down menus, decisions relating to vehicle type, gas type, and equipment type, in both part 3 and part 4 of user interface 600, are restricted to certain possible values. In this way, the user is assisted in constructing a plan that is consistent with the model 120. Other user interface mechanisms will be readily apparent to the skilled practitioner for restricting the user to making decisions about values to assign to parameters characterizing the dimensions, materials, construction, and maintenance specific to each predefined type of stormwater management infrastructure employed, in a manner that is consistent with the model 120.

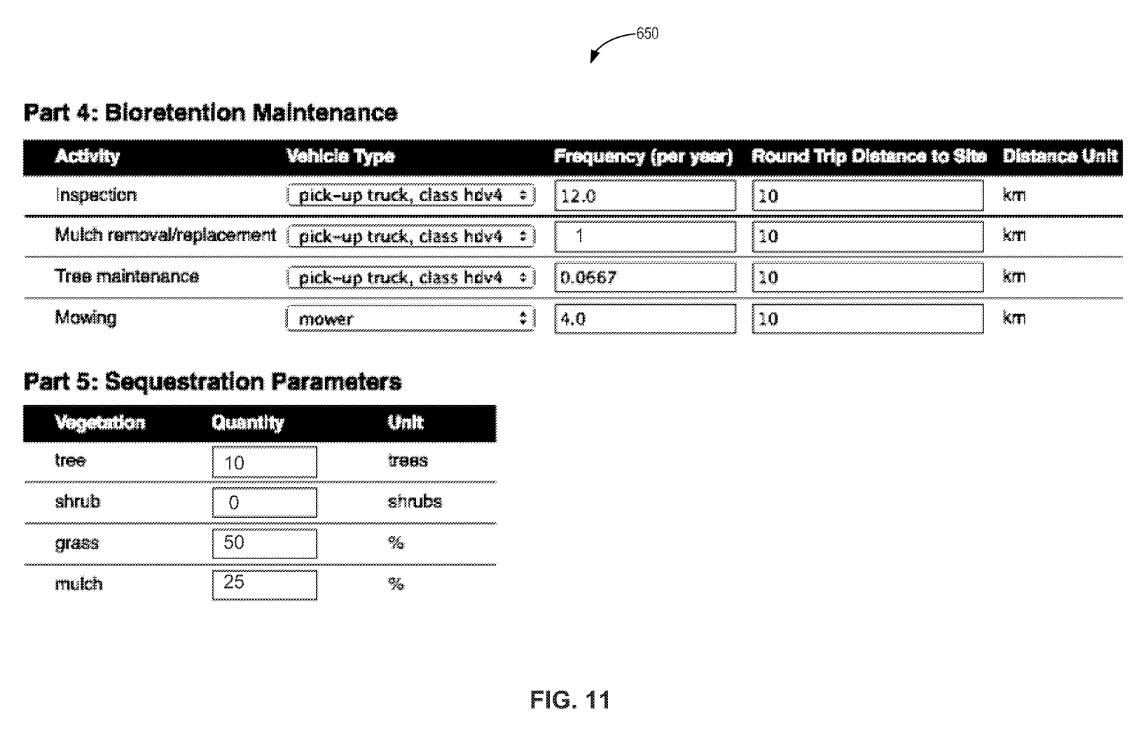

FIG. 11 illustrates a user interface 650 for assisting a user to construct a plan by presenting the user with decisions about maintenance and carbon sequestering materials. Part 4 of user interface 650 relates to the maintenance of the bioretention cell. Because the user of user interface 650 has decided that maintenance of the bioretention cell will include inspection, mulch removal/replacement, tree maintenance, and mowing, the user is presented with decisions about what vehicle should support each maintenance activity, the frequency with which each activity should be performed per year, and the round trip distance that the vehicle will have to make to the maintenance site. In user interface 650, the user has decided that a class 4 pick-up truck will support inspection, mulch removal/replacement and tree maintenance activities. For the mowing, however, the user has decided that a mower will be used. The user has decided that inspection will take place twelve times per year (i.e., monthly), mulch removal/replacement will occur once a year, tree maintenance will be performed 0.0667 times per year (i.e., approximately once every 15 years), and mowing will occur four times a year (i.e., quarterly). The user has also decided that the maintenance equipment will need to make a 10 kilometer round trip to the site to conduct these activities.

Part 5 of user interface 650 relates to carbon sequestering materials to be used for the bioretention cell. The user has decided that there should be trees, grass, and mulch, but not shrubs. Accordingly, maintenance activities (as indicated in Part 4) include mowing, to tend to the grass (as indicated in Part 5), tree maintenance to replace trees and shrubs, and mulch removal/replacement to tend to the mulch. Similarly to user interface 600, decisions in user interface 650 can be restricted, with regard to possible values that can be assigned to various parameters, through the use of pull-down menus to assist the user in constructing a plan that is consistent with the model 120. These restrictions also serve to maintain consistency between various aspects of the plan despite decisions made by the user that might increase overall plan complexity.

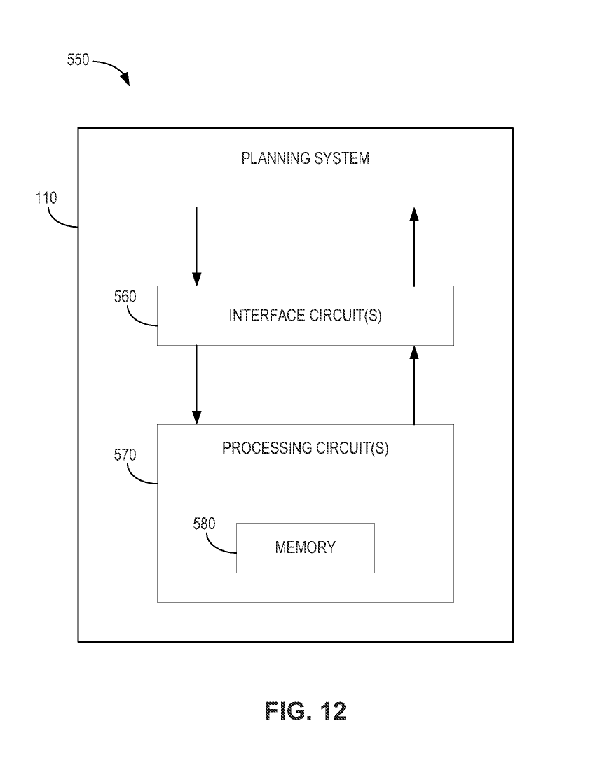

FIG. 12 illustrates exemplary hardware 550 useful for implementing the planning system 110 described herein. The hardware 550 implementing the planning system 110 comprises one or more interface circuits 560. The one or more interface circuits 560 accept input from a user, communicate information to be presented to a user, and exchange messages over a network with other computing devices. The hardware 550 further comprises one or more processing circuits 570. The one or more processing circuits 570 include a memory 580 for storing information being processed. In some embodiments, the memory stores the model 120.

This exemplary hardware 550 is useful for implementing the methods 150, 200, 500 of FIGS. 2, 3 and/or 9. The one or more processing circuits 570 are configured to model predefined types of stormwater management infrastructure as predefined sets of parameters characterizing the dimensions, materials, construction, and maintenance specific to each predefined type, including restricting possible values of at least one parameter characterizing materials, construction, and maintenance to one or more predefined values (block 160). The one or more interface circuits 560 are configured to assist a user to construct alternative plans for managing the land's stormwater that differ in the one or more predefined types of stormwater management infrastructure that the plans employ and/or in the dimensions, materials, construction, or maintenance of a predefined type of infrastructure common to the plans (block 170). This assisting comprises presenting the user with decisions about how to manage the land's stormwater and forming the alternative plans based on how the user makes those decisions. These decisions include a decision about which one or more of the predefined types of stormwater management infrastructure to employ and decisions about the values to assign to parameters characterizing the dimensions, materials, construction, and maintenance specific to each predefined type employed.

The one or more processing circuits are further configured to calculate a net carbon footprint of each alternative plan by calculating the individual carbon footprint of each predefined type of stormwater management infrastructure included in that plan (block 180). The calculating is according to type-specific equations and include aggregating the individual carbon footprints if the user includes multiple types in the plan. The type-specific equations formulate any carbon embodied in the materials, emitted during the construction, emitted during the maintenance, and sequestered by the materials of a type of stormwater management infrastructure as a function of the values assigned by the user to parameters characterizing the dimensions and/or materials specific to that type. The one or more interface circuits are further configured to present, to the user, information identifying one or more of the alternative plans and/or one or more of the net carbon footprints for determining which of the alternative plans most closely achieves a target net carbon footprint (block 190).

In addition, a computer program product stored in a non-transitory computer readable medium for controlling the hardware 550 comprises software instructions which, when run on hardware 550, cause the hardware 550 to perform the various methods and processes described herein, e.g., the methods 150, 200, 500 of FIGS. 2, 3 and/or 9.

Those skilled in the art will appreciate that the various methods and processes described herein may be implemented using various hardware configurations that generally, but not necessarily, include the use of one or more microprocessors, microcontrollers, digital signal processors, or the like, coupled to memory storing software instructions or data for carrying out the techniques described herein. In particular, those skilled in the art will appreciate that the circuits of various embodiments of the router may be configured in ways that vary in certain details from the broad descriptions given above. For instance, one or more of the processing functionalities discussed above may be implemented using dedicated hardware, rather than a microprocessor configured with program instructions. Such variations, and the engineering tradeoffs associated with each, will be readily appreciated by the skilled practitioner. Since the design and cost tradeoffs for the various hardware approaches, which may depend on system-level requirements that are outside the scope of the present disclosure, are well known to those of ordinary skill in the art, further details of specific hardware implementations are not provided herein.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein. Although steps of various processes or methods described herein may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention.

What is claimed is:

1. A method for planning the landscaping of a particular piece of land in terms of carbon footprint, wherein the method comprises the following implemented by one or more processing circuits of a planning system:
modeling predefined types of stormwater management infrastructure as predefined sets of parameters characterizing the dimensions, materials, construction, and maintenance specific to each predefined type, including restricting possible values of at least one parameter characterizing materials, construction, and maintenance to one or more predefined values;
assisting a user to construct alternative plans for managing the land's stormwater that differ in the one or more predefined types of stormwater management infrastructure that the plans employ and/or in the dimensions, materials, construction, or maintenance of a predefined type of infrastructure common to the plans, wherein said assisting comprises presenting the user with decisions about how to manage the land's stormwater and forming the alternative plans based on how the user makes those decisions, said decisions including a decision about which one or more of the predefined types of stormwater management infrastructure to employ and decisions about the values to assign to parameters characterizing the dimensions, materials, construction, and maintenance specific to each predefined type employed;
calculating a net carbon footprint of each alternative plan by calculating the individual carbon footprint of each predefined type of stormwater management infrastructure included in that plan according to type-specific equations and aggregating the individual carbon footprints if the user includes multiple types in the plan, wherein the type-specific equations formulate any carbon embodied in the materials, emitted during the construction, emitted during the maintenance, and sequestered by the materials of a type of stormwater management infrastructure as a function of the values assigned by the user to parameters characterizing the dimensions and/or materials specific to that type; and
presenting, to the user, information identifying one or more of the alternative plans and/or one or more of the net carbon footprints for determining which of the alternative plans most closely achieves a target net carbon footprint.

2. The method of claim 1, wherein forming the alternative plans comprises forming the alternative plans exclusively from the decisions made by the user such that the alternative plans are explicitly specified by the user.

3. The method of claim 1, wherein forming the alternative plans comprises identifying an unmade decision as a decision that was presented to the user but that was not made by the user and autonomously forming different alternative plans from different possible ways that the user could have made that decision.

4. The method of claim 3, wherein the unmade decision is a decision between which of multiple predefined values to assign to a parameter characterizing the dimensions, materials, construction, or maintenance specific to a type of stormwater management infrastructure to be employed.

5. The method of claim 3, further comprising evaluating the net carbon footprints to identify which of the alternative plans most closely achieves the target net carbon footprint, and wherein said presenting comprises presenting information identifying the alternative plan that most closely achieves the target net carbon footprint so as to inform the user of how to make the unmade decision.

6. The method of claim 1, further comprising evaluating the net carbon footprints to identify which of the alternative plans most closely achieves the target net carbon footprint, and wherein said presenting comprises presenting information identifying that alternative plan.

7. The method of claim 1, wherein calculating the net carbon footprint of an alternative plan that employs multiple types of stormwater management infrastructure comprises calculating that footprint to exclude carbon emissions eliminated by simultaneously constructing and/or maintaining those types with the same equipment.

8. The method of claim 1, wherein the predefined types of stormwater management infrastructure include two or more of a bioretention cell, a bioinfiltration cell, permeable pavement, a stormwater detention basin, a rainwater cistern, a sand filter, a wetland, a green roof, a level spreader, a vegetated filter strip, a reinforced concrete pipe, a concrete channel, a rock-lined channel, and a swale.

9. The method of claim 1, wherein one of said parameters characterizing the materials specific to a predefined type characterizes a kind or mix of vegetation employed by that predefined type, the possible values of that parameter being restricted to multiple predefined kinds or mixes of vegetation.

10. The method of claim 1, wherein one of said parameters characterizing the construction or maintenance specific to a predefined type characterizes a class or payload size of equipment employed for that construction or maintenance, the possible values of that parameter being restricted to multiple predefined classes or payload sizes.

11. The method of claim 1, wherein the type-specific equations formulate carbon emitted during the maintenance of a type of infrastructure that has a mulched area to account for the replacement and/or decomposition of the mulch in that area over time, as a function of the dimensions of the mulched area.

12. The method of claim 1, wherein the type-specific equations formulate carbon emitted during the maintenance of a type of infrastructure that has pavement to account for the sweeping of that pavement, as a function of the dimensions of that pavement.

13. The method of claim 1, wherein the type-specific equations formulate carbon emitted during the maintenance of a type of infrastructure that has a forebay to account for the cleanout of that forebay, as a function of the dimensions of that forebay.

14. The method of claim 1, wherein the type-specific equations formulate carbon sequestered by the trees or turf of a type of infrastructure that has such trees or turf, as a function of the values respectively assigned by the user to parameters characterizing the kind of such trees or turf.

15. The method of claim 1, wherein the type-specific equations formulate carbon sequestered by a rainwater cistern to account for the amount of potable water conserved over a defined time by re-using stormwater rather than that potable water.

16. The method of claim 1:
wherein said alternative plans are also for landscaping the land with hardscapes and/or greenscapes;
wherein said modeling further comprises modeling predefined types of hardscapes and/or greenscapes as predefined sets of hardscape and/or greenscape parameters characterizing the dimensions, materials, construction, and maintenance specific to each of those predefined types, including restricting possible values of at least one hardscape and/or greenscape parameter characterizing materials, construction, and maintenance to one or more predefined values;
wherein said assisting further comprises presenting the user with decisions about which one or more of the predefined types of hardscapes and/or greenscapes to employ and decisions about the values to assign to hardscape and/or greenscape parameters characterizing the dimensions, materials, construction, and maintenance specific to each of those predefined types employed;
wherein calculating the net carbon footprint of each alternative plan comprises calculating the individual carbon footprint of each predefined type of hardscape and/or greenscape included in that plan according to type-specific hardscape and/or greenscape equations and aggregating those individual carbon footprints if the user includes multiple types of hardscapes and/or greenscapes in the plan, wherein the type-specific hardscape and/or greenscape equations formulate any carbon embodied in the materials, emitted during the construction, emitted during the maintenance, and sequestered by the materials of a type of hardscape and/or greenscape as a function of the values assigned by the user to parameters characterizing the dimensions and/or materials specific to that type.

17. A method for planning the landscaping of a particular piece of land in terms of carbon footprint, wherein the method comprises the following implemented by one or more processing circuits of a planning system:
modeling predefined types of stormwater management infrastructure as predefined sets of parameters characterizing the dimensions, materials, construction, and maintenance specific to each predefined type, including restricting possible values of at least one parameter characterizing materials, construction, and maintenance to one or more predefined values;
constructing a plan for managing the land's stormwater by presenting the user with decisions about the plan and forming the plan based on how the user makes those decisions, said decisions including a decision about which one or more of the predefined types of stormwater management infrastructure to include in the plan and decisions about the values to assign to parameters characterizing the dimensions, materials, construction, and maintenance specific to each predefined type included in the plan;
calculating a net carbon footprint of the plan by calculating the individual carbon footprint of each predefined type of stormwater management infrastructure included in the plan according to type-specific equations and aggregating the individual carbon footprints if the user includes multiple types in the plan, wherein the type-specific equations formulate any carbon embodied in the materials, emitted during the construction, emitted during the maintenance, and sequestered by the materials of a type of stormwater management infrastructure as a function of the values assigned by the user to parameters characterizing the dimensions and/or materials specific to that type; and
presenting the net carbon footprint of the plan to the user.

18. The method of claim 17, wherein the predefined types of stormwater management infrastructure include two or more of a bioretention cell, a bioinfiltration cell, permeable pavement, a stormwater detention basin, a rainwater cistern, a sand filter, a wetland, a green roof, a level spreader, a vegetated filter strip, a reinforced concrete pipe, a concrete channel, a rock-lined channel, and a swale.

19. The method of claim 17, wherein one of said parameters characterizing the materials specific to a predefined type characterizes a kind or mix of vegetation employed by that predefined type, the possible values of that parameter being restricted to multiple predefined kinds or mixes of vegetation.

20. The method of claim 17, wherein one of said parameters characterizing the construction or maintenance specific to a predefined type characterizes a class or payload size of equipment employed for that construction or maintenance, the possible values of that parameter being restricted to multiple predefined classes or payload sizes.

21. The method of claim 17, wherein the type-specific equations formulate carbon emitted during the maintenance of a type of infrastructure that has a mulched area to account for the replacement and/or decomposition of the mulch in that area over time, as a function of the dimensions of the mulched area.

22. The method of claim 17, wherein the type-specific equations formulate carbon emitted during the maintenance of a type of infrastructure that has pavement to account for the sweeping of that pavement, as a function of the dimensions of that pavement.

23. The method of claim 17, wherein the type-specific equations formulate carbon emitted during the maintenance of a type of infrastructure that has a forebay to account for the cleanout of that forebay, as a function of the dimensions of that forebay.

24. The method of claim 17, wherein the type-specific equations formulate carbon sequestered by the trees or turf of a type of infrastructure that has such trees or turf, as a function of the values respectively assigned by the user to parameters characterizing the kind of such trees or turf.

25. The method of claim 17, wherein the type-specific equations formulate carbon sequestered by a rainwater cistern to account for the amount of potable water conserved over a defined time by re-using stormwater rather than that potable water.

26. The method of claim 17:
wherein said plan is also for landscaping the land with hardscapes and/or greenscapes;
wherein said modeling further comprises modeling predefined types of hardscapes and/or greenscapes as predefined sets of hardscape and/or greenscape parameters characterizing the dimensions, materials, construction, and maintenance specific to each of those predefined types, including restricting possible values of at least one hardscape and/or greenscape parameter characterizing materials, construction, and maintenance to one or more predefined values;
wherein said constructing further comprises presenting the user with decisions about which one or more of the predefined types of hardscapes and/or greenscapes to include in the plan and decisions about the values to assign to hardscape and/or greenscape parameters characterizing the dimensions, materials, construction, and maintenance specific to each of those predefined types included in the plan;
wherein calculating the net carbon footprint of the plan comprises calculating the individual carbon footprint of each predefined type of hardscape and/or greenscape included in the plan according to type-specific hardscape and/or greenscape equations and aggregating those individual carbon footprints if the user includes multiple types of hardscapes and/or greenscapes in the plan, wherein the type-specific hardscape and/or greenscape equations formulate any carbon embodied in the materials, emitted during the construction, emitted during the maintenance, and sequestered by the materials of a type of hardscape and/or greenscape as a function of the values assigned by the user to parameters characterizing the dimensions and/or materials specific to that type.

27. A planning system for planning the landscaping of a particular piece of land in terms of carbon footprint, the planning system comprising:
one or more processing circuits configured to model predefined types of stormwater management infrastructure as predefined sets of parameters characterizing the dimensions, materials, construction, and maintenance specific to each predefined type, including restricting possible values of at least one parameter characterizing materials, construction, and maintenance to one or more predefined values;
one or more interface circuits configured to assist a user to construct alternative plans for managing the land's stormwater that differ in the one or more predefined types of stormwater management infrastructure that the plans employ and/or in the dimensions, materials, construction, or maintenance of a predefined type of infrastructure common to the plans, wherein said assisting comprises presenting the user with decisions about how to manage the land's stormwater and forming the alternative plans based on how the user makes those decisions, said decisions including a decision about which one or more of the predefined types of stormwater management infrastructure to employ and decisions about the values to assign to parameters characterizing the dimensions, materials, construction, and maintenance specific to each predefined type employed;
wherein the one or more processing circuits are further configured to calculate a net carbon footprint of each alternative plan by calculating the individual carbon footprint of each predefined type of stormwater management infrastructure included in that plan according to type-specific equations and aggregating the individual carbon footprints if the user includes multiple types in the plan, wherein the type-specific equations formulate any carbon embodied in the materials, emitted during the construction, emitted during the maintenance, and sequestered by the materials of a type of stormwater management infrastructure as a function of the values assigned by the user to parameters characterizing the dimensions and/or materials specific to that type; and
wherein the one or more interface circuits are further configured to present, to the user, information identifying one or more of the alternative plans and/or one or more of the net carbon footprints for determining which of the alternative plans most closely achieves a target net carbon footprint.

28. The planning system of claim 27, wherein the one or more processing circuits of the planning system are configured to model predefined types of stormwater management infrastructure by modeling two or more of a bioretention cell, a bioinfiltration cell, permeable pavement, a stormwater detention basin, a rainwater cistern, a sand filter, a wetland, a green roof, a level spreader, a vegetated filter strip, a reinforced concrete pipe, a concrete channel, a rock-lined channel, and a swale.
